(19) United States
(12) Patent Application Publication
(10) Pub. No.: US 2024/0013426 A1
(43) Pub. Date: Jan. 11, 2024

(54) IMAGE PROCESSING SYSTEM AND METHOD FOR IMAGE PROCESSING

(71) Applicant: Fujitsu Limited, Kawasaki-shi (JP)

(72) Inventor: Xuying LEI, Kawasaki (JP)

(73) Assignee: Fujitsu Limited, Kawasaki-shi (JP)

(21) Appl. No.: 18/182,416

(22) Filed: Mar. 13, 2023

(30) Foreign Application Priority Data
Jul. 11, 2022 (JP) 2022-111047

(51) Int. Cl. G06T 7/70; G06T 5/50; G06T 9/00; G06V 10/28; G06V 10/44; G06V 10/75

(52) U.S. Cl. CPC G06T 7/70; G06T 5/50; G06T 9/00; G06V 10/28; G06V 10/44; G06V 10/758; G06T 2207/20221; G06T 2207/30242

(57) ABSTRACT

An image processing system includes: devices that obtain inputted images; servers that perform an inference process on the inputted images; and a controlling apparatus that controls the devices and the servers. A first device obtains a first feature of a first image by inputting the first image into a former-part layer of a machine learning model that performs the inference process, calculates statistics information of the first feature and transmits to the controlling apparatus. The controlling apparatus determines a network band and a first server based on the statistics information and performance of each server, the network band being allocated to the first device. The first device transmits the first feature to the first server based on the network band. The first server obtains an inference result by inputting the first feature received from the first device into a latter-part layer of the machine learning model.

### CROSS-REFERENCE TO RELATED APPLICATION

This application is based upon and claims the benefit of priority of the prior Japanese Patent application No. 2022-111047, filed on Jul. 11, 2022, the entire contents of which are incorporated herein by reference.

### FIELD

The embodiment discussed herein relates to an image processing system and a method for image processing.

### BACKGROUND

There is known a technique that offloads an inference process based on a frame image captured by an edge terminal (device) such as a camera, the process being exemplified by an object detecting process that detects an object such as a person, to an edge server (server) such as a cloud server.

The above technique occasionally allocates a network band to transmit frame images from multiple edge terminals to an edge server equally to the multiple edge terminals.

One of the known methods to transmit frame images transmits a difference between frames to reduce the communication data traffic.

For example, related art is disclosed in US Patent Application Publication No. 2011/0255590.

### SUMMARY

According to an aspect of the embodiments, an image processing system including: a plurality of devices that obtain a plurality of inputted images; a plurality of servers that perform an inference process on the plurality of inputted images; and a controlling apparatus that controls the plurality of devices and the plurality of servers. A first device that obtains a first inputted image and that is one of the plurality of devices is configured to obtain a first feature of the first inputted image by inputting the first inputted image into a former-part layer of a machine learning model, the machine learning model performing the inference process on an image inputted, calculate statistics information of the first feature and transmit the statistics information to the controlling apparatus, and transmit the first feature to a first server based on a network band determined by the controlling apparatus, the first server being determined among the plurality of servers by the controlling apparatus. The controlling apparatus is configured to determine the network band and the first server based on the statistics information received from the first device and performance of each of the plurality of servers, the network band being allocated to the first device. The first server is configured to obtain an inference result by inputting the first feature received from the first device into a latter-part layer of the machine learning model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a system according to a first comparative example;

FIG. 2 is a block diagram illustrating an example of a configuration of a system according to a second comparative example;

FIG. 3 is a block diagram illustrating an example of a configuration of a system according to a one embodiment;

FIG. 4 is a block diagram illustrating an example of a software configuration of the system according to the one embodiment;

FIG. 5 is a block diagram illustrating an example of an object detecting model of the one embodiment;

FIG. 6 is a diagram illustrating an example of a quantizing process and an inverse quantizing process based on a network band;

FIG. 7 is a diagram illustrating an example of a determining process of a transmission destination;

FIG. 8 is a diagram illustrating an example of a frame image and a feature;

FIG. 9 is a diagram illustrating an example of a timing chart of processes performed in the system of the one embodiment;

FIG. 10 is a flow diagram illustrating an example of an operation of an edge terminal of the one embodiment;

FIG. 11 is a flow diagram illustrating an example of an operation of an edge server of the one embodiment;

FIG. 12 is a flow diagram illustrating an example of an operation of a controlling server of the one embodiment;

FIG. 13 is a block diagram illustrating an example of a software configuration of an edge terminal according to a first modification; and

FIG. 14 is a block diagram illustrating an example of a hardware configuration of a computer of the one embodiment.

### DESCRIPTION OF EMBODIMENT(S)

In the above technique, a network band allocated to an edge terminal transmitting frame images containing may moving objects (i.e., having large differences between frames) sometimes lacks, which may cause deterioration in image quality when such frames are transmitted, leading to lowering the accuracy in object detection in the server.

Furthermore, if the combination of each edge terminal and an edge server that performs an object detection process for the edge terminal is fixedly determined, load is concentrated on a particular edge server according to an inputted image and real-time object detection is sometimes not successfully accomplished.

As such, the above technique may sometimes make it impossible to appropriately execute an inference process exemplified by an object detecting process.

Hereinafter, the embodiments of the present disclosure will now be described with reference to the drawings. However, the embodiments described below are merely illustrative and there is no intention to exclude the application of various modifications and techniques that are not explicitly described in the embodiment. For example, the present embodiment can be variously modified and implemented without departing from the scope thereof. In the drawings used in the following description, the same reference numerals denote the same or similar parts unless otherwise specified.

### (A) System of Comparative Examples

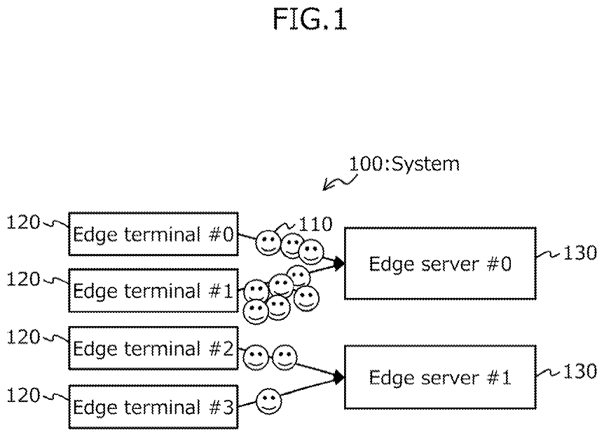

FIG. 1 is a block diagram illustrating an example of a configuration of a system 100 according to a first comparative example. As illustrated in FIG. 1, the system 100 includes multiple edge terminals 120 and multiple edge servers 130. Hereinafter, particular edge terminals 120 are represented by edge terminals #0 to #3 (see FIG. 1) and also particular edge server 130 are represented by edge servers #0 and #1 (see FIG. 1).

Each edge terminal 120 is a device connected to an image capturing device such as a camera, and obtains a frame image 110 from the image capturing device, and transmits the obtained frame image 110 to one of the edge servers 130. An example of a frame image 110 may be a one-frame image in a camera image containing a person as illustrated by a face mark in FIG. 1.

Each edge server 130 is, for example, a computer such as a cloud server, and performs an object detecting process on a frame image 110 received from the edge terminal 120 and outputs a detection result of an object, for example, a person.

In the system 100 illustrated in FIG. 1, for example, when a person contained in a camera image is on the move, the positions and the numbers of people contained in the frame images 110 vary.

Therefore, if the network band between an edge terminal 120 and the edge server 130 is equally allocated to the respective edge terminals 120, the network band allocated to the edge terminal #1 that transmits a frame image 110 in which a large number of people appear, for example, lacks.

For example, when encoding a frame image 110, each edge terminal 120 reduces the data traffic by calculating a difference image between frames B and P and transmitting the difference image. However, when the number of people appearing in a camera image increases like the edge terminal #1, the difference between the current frame and the previous frame increases and the data volume of the difference image to be transmitted increases, so that the network band to be used for the transmission increases.

If a frame image 110 is transmitted from the edge terminal #1 through the insufficient network band, the image quality may deteriorate and the accuracy in detecting an object in the edge server #0 may be degraded.

In addition, if the combination of the edge terminal 120 and the edge server 130 are fixedly allocated, load is concentrated on a particular edge server 130, and real-time analyzing process (detecting process) may not be achieved.

Here, the edge server 130 is assumed to use YOLO v3 as an object detecting model that performs the object detecting process. YOLO v3 is a model that detects a position of an object contained in an inputted image and predicts the name of the object. Since YOLO v3 detects the position (bounding box) of every object contained in an inputted image and calculates the classification of the category to which every object in the image belongs, increase the number of objects increases the processing load.

For example, in FIG. 1, the edge server #0 processes the frame images 110 from the edge terminals #0 and #1, and the edge server #1 processes the frame image 110 from the edge terminals #2 and #3. In this situation, since the edge terminals #0 and #1 both transmit frame images 110 containing a larger number of people than the edge terminals #2 and #3, the processing load of the object detecting process in the edge server #0 increases, in other words, uses more calculation power.

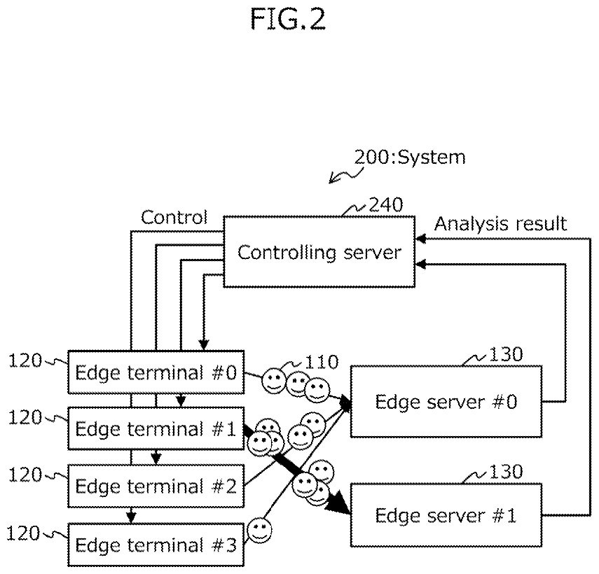

FIG. 2 is a block diagram illustrating an example of a configuration of a system 200 according to a second comparative example. The system 200 includes a controlling server 240 in addition to the multiple edge terminals 120 and the multiple edge servers 130.

The controlling server 240 performs feedback control on each edge terminal 120 on the basis of an analysis result of the object detecting process performed by each edge server 130.

For example, the controlling server 240 dynamically controls network bands allocated to respective edge terminals 120 and an edge server 130, which is a transmission destination of a frame image 110 from each edge terminal 120, in accordance with the number of detected objects based on the analysis result of a previous frame image(s) 110.

Thus, as illustrated in FIG. 2, the system 200 can control, such that the edge server #0 processes the frame images 110 from the edge terminals #0, #2, and #3, and the edge server #1 processes the frame image 110 from the edge terminal #1. This can disperse the load in terms of the number detected objects.

However, in the feedback control by controlling server 240 in the system 200, a delay may occur in calculation of the number of detected objects, transmission through a network, and the like. For example, if a camera image is of 30 fps (frames per second), the output pitch of a frame image 110 from the camera will be 33 msec (milliseconds). In contrast, a delay is, for example, 100 msec or the like. Therefore, the feedback control is, for example, control based on a frame image 110 of three or more frames before.

If such a delay occurs, the feedback control may not catch up the moving object, that is, with change in the person flow, and the accuracy of the feedback control may be degraded. In this situation, the system 200 has a possibility that the lack of a network band and increase of the processing load in each server 130 in the system 100 of FIG. 1 are not sometimes solved.

### (B) Configuration Example of System According to One Embodiment

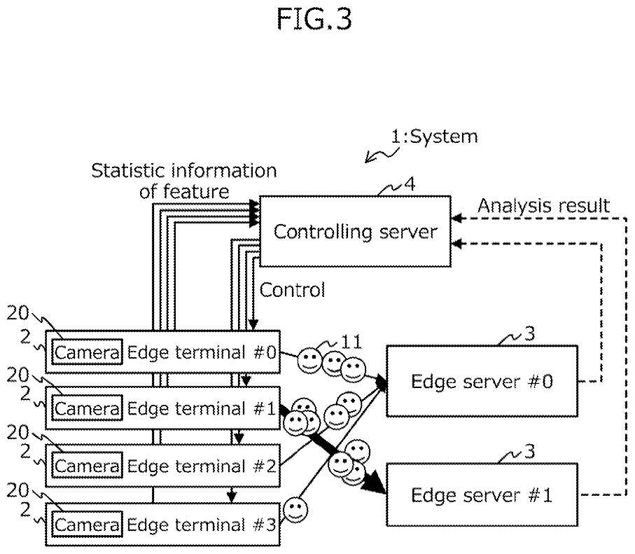

FIG. 3 is a block diagram illustrating an example of a configuration of a system 1 according to a one embodiment. The system 1 is an example of an example of an image processing system or an image inferring system in which multiple edge servers 3 executes an inference process on frame images 11 that multiple terminals 2 obtain.

For example, the system 1 may be applied to a system that performs an inference process on an inputted image, using a machine learning model, and that performs various processes using the inference result. For example, the system 1 may be applied to a system that recognizes an image photographed by a camera disposed in a factory, using a machine learning model, and detects defectives and abnormality of the operating device to enhance the product quality and the productivity. Alternatively, the system 1 may be applied to, for example, a system that analyzes the flow (people flow) of people in a commercial facility in real time and uses the analysis result for the purpose of marketing, streamlining operations, attracting customers, avoiding dense states against corona virus, and the like.

The one embodiment assumes that the inference process is an object detecting process, but is not limited thereto. As illustrated in FIG. 3, the system 1 includes multiple edge terminals 2, multiple edge servers 3, and a controlling server 4.

The multiple edge terminals 2 are an example of multiple devices that obtain inputted images. Each edge terminal 2 is a device connected to a camera 20 and obtains frame images 11 from the camera 20. The camera 20 is an example of an image-capturing device, and a frame image 11 is an example of an inputted image. The function of the edge terminal 2 may be a function that the camera 20 has and that is exemplified by a part of a communication function. In this case, the camera 20 may operate as the edge terminal 2.

The multiple edge server 3 are an example of multiple servers that carry out an inference process on the inputted images. The edge server 3 is exemplified by a computer such as a cloud server and carries out an object detecting process, using image based on a frame image 11 received from the edge terminal 2. The object detecting process is an example of an inference process, and may be executed by inputting information into a trained machine learning model, such as an object detecting model.

The controlling server 4 is an example of a controlling apparatus that controls the multiple edge terminals 2 and the multiple edge servers 3.

The controlling server 4 receives, from each of multiple edge terminals 2, statistic information of the feature of the frame image 11, and determines, based on the received statistic information and the performance of each of the multiple edge servers 3, a network band to be allocated to each edge terminal 2 and an edge server 3 to serve as a transmission destination.

An edge server 3 to serve as a transmission destination is an edge server 3 that is to be a receiver of a frame image 11 based on which the statistic information received from an edge terminal 2 is calculated. An example of the statistic information is a variance value of a feature. Examples of the performance of the edge server 3 includes calculation power of the edge server 3 exemplified by an index indicating the processing performance of a hardware resource such as a processor. The edge server 3 may transmit information indicating the processing performance to the controlling server 4 at a predetermined timing, such as before or after the operation of the system 1 or a periodic timing.

In the above manner, the controlling server 4 performs feedforward control. As indicated by the broken lines in FIG. 3, the controlling server 4 may perform feedback control on each edge terminal 2 on the basis of the analysis result (inference result) obtained by each edge server 3. As an example, the controlling server 4 may correct, on the basis of the number of detected objects of the inference result of one or more previous frame images 11, the feedforward control based on the statistic information obtained from each edge terminal 2 and the performance of each of the multiple edge servers 3.

### (C) Example of Software Configuration

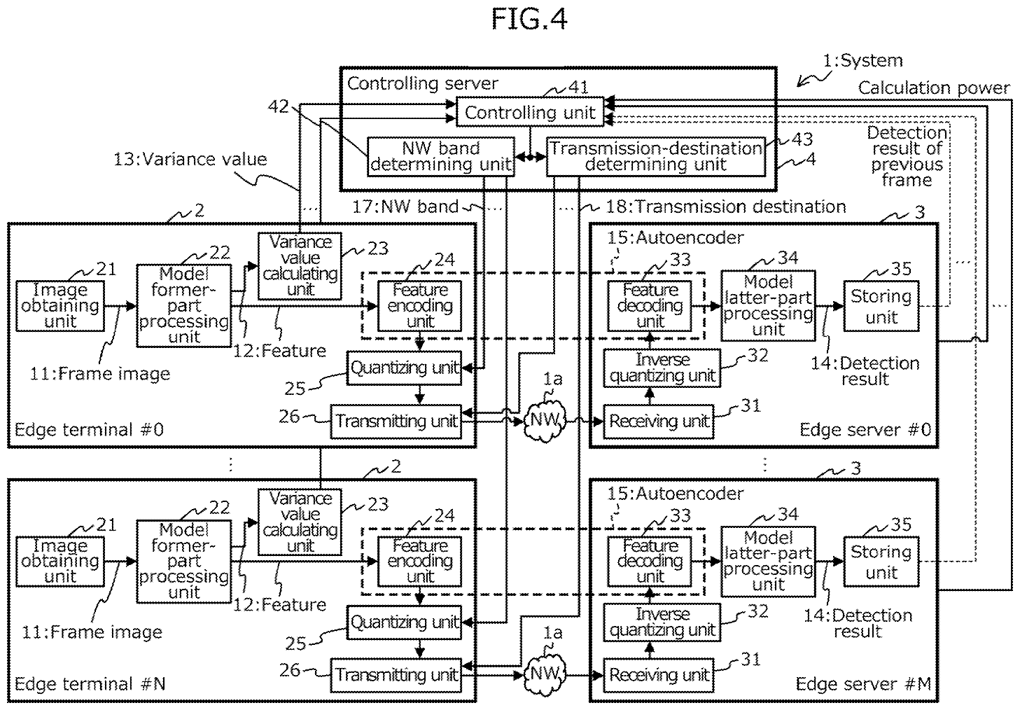

FIG. 4 is a block diagram illustrating an example of a software configuration of the system 1 according to the one embodiment. In the example of FIG. 4, the system 1 includes N+1 (N is an integer of one or more) edge terminals 2, M+1 (M is an integer of one or more) edge servers 3, and the controlling server 4.

The multiple edge terminals 2 may be communicably connected to the multiple edge servers 3 via a network (NW) 1a. The NW 1a may be formed by a variety of NWs, including one of or the both a Local Area Network (LAN) and the internet. The NW 1a may include one of or the both of a wired NW and a wireless NW.

One or both of between an edge terminal 2 and the controlling server 4 and between an edge server 3 and the controlling server 4 may be communicably connected to each other by the NW 1a, or may be communicably connected to each other by a NW other than NW 1a.

As illustrated in FIG. 4, the edge terminal 2 may include an image obtaining unit 21, a model former-part processing unit 22, a variance value calculating unit 23, a feature encoding unit 24, a quantizing unit 25, and a transmitting unit 26.

The image obtaining unit 21 obtains a frame image 11 captured by the camera 20. A frame image 11 is one of multiple time-series consecutive images, for example, a moving image such as a camera image.

The model former-part processing unit 22 performs a former-part process of a trained machine learning model, which performs an inference process on a frame image 11, and outputs a feature 12 of the frame image 11. An example of the feature 12 is a feature map.

An example of the former-half of the machine learning model is one or more layers from the first layer of the machine learning mode to a layer that outputs the feature 12 of a frame image 11, such as a convolutional layer. In other words, the model former-part processing unit 22 inputs a frame image 11 into the machine learning model and obtains the feature 12 which is the outputted data of an intermediate layer of the machine learning model.

An examples of the machine learning model includes an object detecting model such as a YOLO. The one embodiment assumes that YOLO v3 is used as the object detecting mode, but the machine learning model may alternatively be a different version of YOLO or another object detecting model except for YOLO. In addition to the object detecting model, the machine learning model may be a trained Artificial Intelligence (AI) model of various Deep Neural Networks (DNNs).

The model former-part processing unit 22 outputs a feature 12 to each of the variance value calculating unit 23 and the feature encoding unit 24.

The variance value calculating unit 23 calculates a variance value 13 of the feature 12 and transmits the calculated variance value 13 to the controlling server 4. The variance value 13 is an example of statistics information of the feature 12.

The feature encoding unit 24 encodes the feature 12 to compress (reduce the data volume of) the feature 12. The encoding process rounds the feature 12 and converts the feature 12 to floating-point data. The encoding process by the feature encoding unit 24 may be accomplished, for example, by inputting the feature 12 into the autoencoder 15 and obtaining data from the intermediate layer of the autoencoder 15.

The quantizing unit 25 performs a pre-transmitting process on the encoded data on the basis of the NW band 17 determined by controlling server 4. The pre-transmitting process may include a quantizing process on the encoded data and an entropy encoding process on the quantized data. The quantizing process converts data to an integer data. The entropy encoding process reduces data volume.

The transmitting unit 26 transmits the transmission data having been subjected to the pre-transmitting process to the predetermined edge server 3 via the NW 1a. The predetermined edge server 3 is an example of the first server, and may be, for example, edge server 3 serving as the transmitting destination 18 determined by the controlling server 4.

As illustrated in FIG. 4, the edge server 3 may include a receiving unit 31, an inverse quantizing unit 32, a feature decoding unit 33, a model latter-part processing unit 34, and a storing unit 35.

The receiving unit 31 receives data from edge terminal 2. Data received by the receiving unit 31 is the feature 12 that has been encoded, quantized, and entropy encoded, and is an example of information based on the frame image 11.

The inverse quantizing unit 32 performs a pre-decoding process on data received by the receiving unit 31. The pre-decoding process may include an inverse entropy encoding process on the received data and an inverse quantizing process of the inverse entropy encoded data. The quantized data is obtained by the inverse entropy encoding process. The encoded feature 12 is obtained by the inverse quantizing process.

The feature decoding unit 33 restores the feature 12 by decoding data subjected to the pre-decoding process, in other words, the encoded (compressed) feature 12. The decoding process by the feature decoding unit 33 may be performed, for example, by inputting the compressed feature 12 into the intermediate layer of the autoencoder 15 and obtaining the feature 12 from the output of autoencoder 15.

The model latter-part processing unit 34 performs, on the encoded feature 12, a process of the latter part of the trained machine learning model that performs an inference process on the frame image 11, and outputs an inference result exemplified by a detection result 14 (analysis result) of the object from inference result from the feature 12.

The latter part of the machine learning model includes, for example, the remaining part of machine learning model, excluding the layers executed by the model former-part processing unit 22, and the remaining part is exemplified by one or more layers from the subsequent layer of the layer that outputs the feature 12 to the last layer.

The storing unit 35 stores the detection result 14 outputted from the model latter-part processing unit 34. The detection result 14 stored in the storing unit 35 may be transmitted to the controlling server 4. The detection result 14 may include, for example, the position and the number of objects detected from the feature 12 of the frame image 11 and the identification information of the frame image 11 in which an object is detected. An example of the identification information may be an frame number. The identification information may include identification information of the edge terminal 2 (or the camera 20).

As the above, the system 1 of FIG. 4 divides the trained machine learning model that performs and inference process into the model former-part processing unit 22 and the model latter-part processing unit 34, and arranges the model former-part processing unit 22 and the model latter-part processing unit 34 in the edge terminal 2 and the edge server 3, respectively.

The system 1 compresses and restores the feature 12 of the intermediate layer of the machine learning model, which feature 12 is outputted from the model former-part processing unit 22 and then inputted to model latter-part processing unit 34, by the feature encoding unit 24 and the feature decoding unit 33. The feature encoding unit 24 and the feature decoding unit 33 collectively serve as an example of the autoencoder 15.

At this time, the system 1 performs, in the edge terminal 2, the pre-transmitting process on the data compressed by the feature encoding unit 24, and transmits the processed data to the edge server 3. Then, in the edge server 3 of the system 1, the feature decoding unit 33 restores data obtained by performing the pre-decoding process on the received data.

With the above-described configuration, the system 1 can reduce the processing load on the edge terminal 2 by offloading at least a part of the inference process from the edge terminal 2 to the edge server 3. In addition, since data having a reduced size smaller than that of the inputting image is transmitted from the edge terminal 2 to the edge server 3, the congestion in the NW 1a can be reduced.

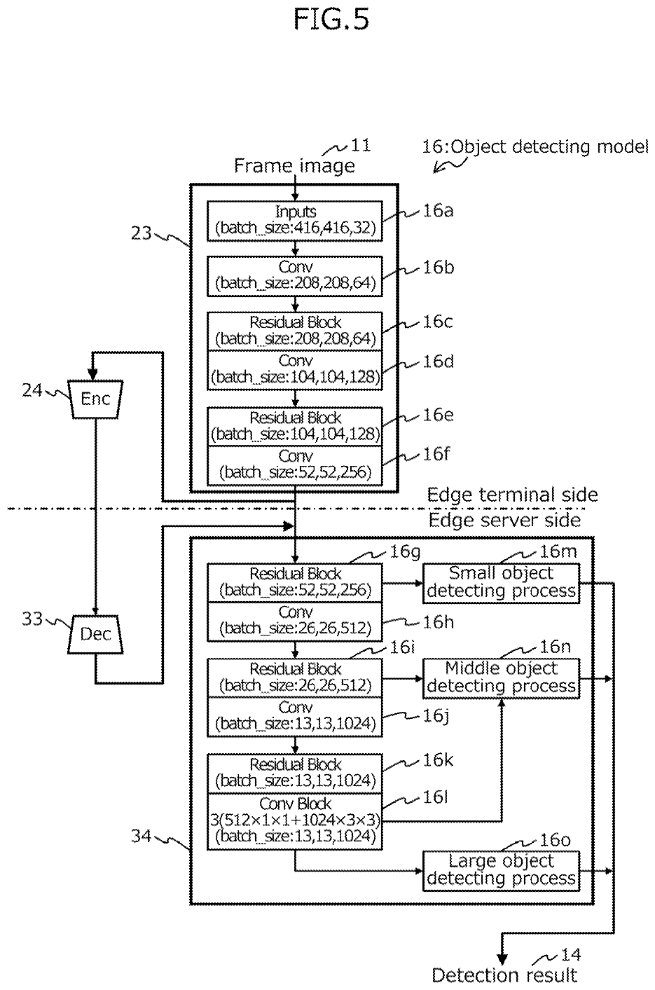

FIG. 5 is a block diagram illustrating an example of an object detecting model 16 of the one embodiment. As illustrated in FIG. 5, the object detecting model 16, which is an example of the machine learning model, may include multiple layers 16a to 161 and multiple object detecting process 16m to 16o. The batch_size in parentheses in each of the layers 16a to 161 represents the size of data (image) output from the layer. For example, the “batch_size: 52, 52, 256” may indicate that the height, the width, and the number of channels of an outputted image are 52, 52, and 256, respectively.

The input layer (Inputs) 16a is a layer to which a frame image 11 is input. The convolutional layers (Cony) 16b, 16d, 16f, 16h, and 16j, and the convolutional layer block (Cony Block) 161 are layers that each perform a convolutional calculation on an image inputted from the previous layer and output the calculation result to the subsequent layer. By the convolutional calculation, the size of the inputted image is reduced. The Residual Blocks 16c, 16e, 16g, 16i, and 16k are layers that each perform multiple convolution calculations on an image inputted from the previous layer.

The small object detecting process 16m is a process to detect a relatively small object contained in the frame image 11 on the basis of the output result of the residual block 16g, and may include multiple layers. The medium object detecting process 16n is a process to detect a relatively medium-sized object contained in the frame image 11 on the basis of the output results of the residual block 16i and the convolutional layer 161, and may include multiple layers. The large object detecting process 16o is a process to detect a relatively large object contained in the frame image 11 on the basis of the output result of the convolutional layer 161. The output result of at least one of the object detection processes 16m to 16o is an example of the detection result 14.

In the example of FIG. 5, each of the layers 16b to 16f is an example of an intermediate layer of the object detecting model 16, and the outputted data from these layers 16b to 16f is an example of the feature 12.

The layers 16a to 16f collectively serve as an example of the process of the former part of the object detecting model 16, and are arranged in the model former-part processing unit 22 of the edge terminal 2. Further, the layers 16g to 161 and the object detecting processes 16m to 16o collectively serve as an example of the process of the latter part of the object detecting model 16, and are arranged in the model latter-part processing unit 34 of the edge server 3.

As illustrated in FIG. 5, the feature 12 outputted from the convolution layer 16f which is an example of the last layer of the former part is inputted to the feature encoding unit 24 of the edge terminal 2 (see FIG. 4). In addition, the feature 12 subjected to the encoding process of the feature encoding unit 24, the pre-transmission process in the edge terminal 2, and the pre-decoding process of the edge server 3 and decoded and outputted by the feature decoding unit 33 is inputted into the residual blocking 16g which is an example of the first layer of the former part.

Note that, in the object detecting model 16, the boundary between the former part and the latter part is not limited to between the convolutional layer 16f and the residual block 16g, and may be after the another convolution layer 16b, 16d, or 16f located before the object detecting process 16m to 16o. For example, the boundary may be between the convolutional layer 16b and the residual block 16c or between the convolutional layer 16d and the residual block 16e.

Returning back to the explanation of FIG. 4, the controlling server 4 determines the NW band 17 and the transmission destination 18 to be allocated to each edge terminal 2 on the basis of the one or more variance values 13 of the one or more frame images 11 received from the one or more edge terminals 2 and calculation power received from the edge servers 3. As illustrated in dashed lines in FIG. 4, the controlling server 4 may determine the NW band 17 and the transmission destination 18 further based on the one or more detection results 14 of the objects of previous (past) frame images 11 received from the edge servers 3.

As illustrated in FIG. 4, the controlling server 4 may include a controlling unit 41, a NW band determining unit 42, and a transmission-destination determining unit 43.

The controlling unit 41 receives the variance value 13 of the current frame image 11 from the edge terminal 2, and receives the calculation power and the detection results 14 of the objects in the one or more previous frame images 11 from the edge server 3. The current frame image 11 is an example of a first inputted image, and the previous frame images 11 are an example of a second inputted image previous in time to the first inputted image. The previous frame images 11 may be, for example, one or more frames image 11 earlier the current frame image 11 by the number of frames corresponding to the delay amount of the feedback control, and may be, for example, one or more frames (for example, three to five frames) earlier than the current frame image 11.

For each of the received variance value 13 and the received detection result 14, the controlling unit 41 may hold at least the latest (most recent) data of each edge terminal 2 in a storing region, such as the memory of the controlling server 4.

When the controlling server 4 does not use the detection result 14 of an object for determining the NW band 17 and the transmission destination 18, the process of the controlling unit 41 to receive and hold the detection result 14 from the edge server 3 may be omitted.

In addition, when obtaining the detection result 14, the controlling unit 41 may perform processing as an AI application for predicting a people flow on the basis of the number of objects and output a processing result such as a prediction result.

The NW band determining unit 42 determines the NW bands 17 to be allocated to the respective edge terminals 2 on the basis of the variance value 13 of the current frame image 11. The NW band determining unit 42 may determine the NW band 17 further on the basis of the detection results 14 of an object of the previous frame image(s) 11.

For example, the NW band determining unit 42 may determine the NW band 17 to be allocated to the i-th (i is an integer from zero to N) edge terminal 2, using the following Expression (1). The NW band 17 may be represented by the rate R1_pred(i).

R1_pred(i)=R_total*var(i)/Σ var (1)

In the above Expression (1), the term R total represents a NW band that can be allocated to the overall multiple (N+1) edge terminals 2. The term var(i) represents a variance value 13 of the current frame image 11 received from the i-th edge terminal 2. The term Σ var represents the sum of variance values 13 of the current frame images 11 received from the multiple (N+1) edge terminals 2.

In this way, the NW band determining unit 42 may allocate R total to the edge terminals 2 by feedforward control according to the ratio of the variance values 13 of the current frame images 11 received from the respective edge terminals 2.

In the each edge terminal 2, the variance value 13 is sequentially calculated at a timing at which the corresponding image capturing device outputs a frame image 11. This means that the timing at which the controlling unit 41 receives the variance value 13 from an edge terminal 2 is different with edge terminal 2.

For the above, for example, when receiving the variance value 13 from the i-th edge terminal 2 and calculating the value of R1_pred(i), the NW band determining unit 42 may use, as variance value 13 of another edge terminal 2, the latest variance value 13 held in the storing region of the controlling server 4.

Further, when using the one or more detection results 14 to determine the NW band 17, the NW band determining unit 42 may calculate the rate R2_pred(i) as the NW band 17 based on the detection results 14, using the following Expression (2).

R2_pred(i)=R_total*num(i)/Σnum (2)

In the above Expression (2), the term num (i) represents the number of objects (one or more detection results 14) detected from the one or more previous frame images 11 of the i-th edge terminal 2. The term Σnum represents the sum of the numbers of objects (detection results 14) detected from the respective previous frame images 11 of multiple (i.e., N+1) edge terminals 2. The NW band determining unit 42 may use the latest detection result 14 held by the controlling server 4 as the number of objects to be used for the calculation of the above Expression (2).

According to the above Expression (2), the NW band determining unit 42 can calculate the rate R2_pred(i) for allocating R total to the respective edge terminals 2 in the feedback control according to the ratio of the number of objects detected on the basis of the one or more previous frame images 11 of each edge terminal 2.

Then, the NW band determining unit 42 may calculate the rate R_pred(i) as the NW band 17 based on both the variance value 13 and the detection result 14 using the following Expression (3).

R_pred(i)=(1−k1)*R1_pred(i)+k1*R2_pred(i) (3)

In the above Expression (3), the term k1 is a weighting factor, and may be a value between 0 and 1 both inclusive. When determining the NW band 17 based on Expression (3), the NW band determining unit 42 may determine the rate R_pred(i) based on the weighted sum of R1_pred(i) and R2_pred(i).

If k1=0 is satisfied, the NW band 17 based only on the variance value 13 between the variance value 13 and the detection result 14 is determined like the above Expression (1). If k1=1 is satisfied, the NW band 17 based only on the detection result 14 between the variance value 13 and the detection result 14 is determined like the above Expression (2). In addition, if 0<k1<1 satisfied, the NW band 17 determined on the basis of the variance value 13 can be corrected according to the number of previous objects based on the detection result 14.

The NW band determining unit 42 transmits the i-th NW band 17 (R1_pred(i) or R_pred(i)) determined on the basis of the above Expression (1) or the above Expression (3) to the i-th edge terminal 2.

For example, the i-th edge terminal 2 performs a quantizing process by the quantizing unit 25 on the basis of the received NW band 17.

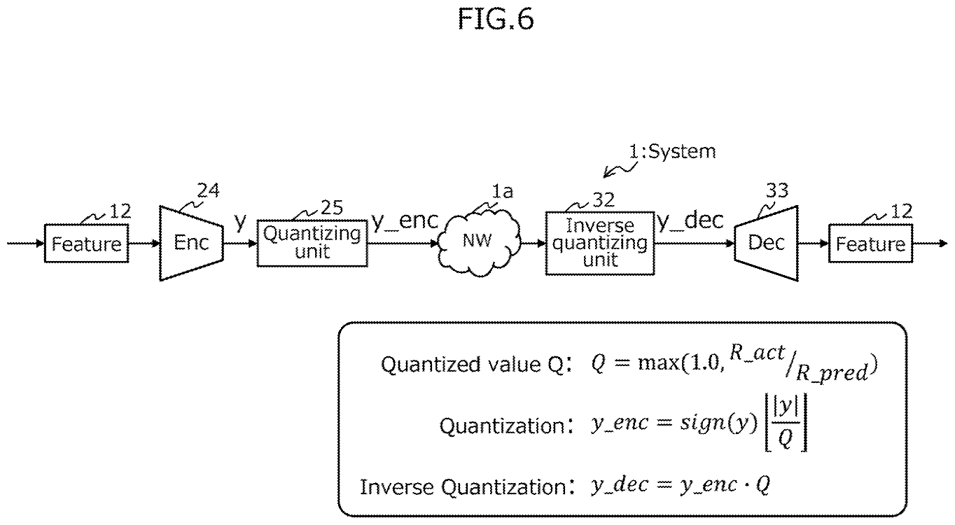

FIG. 6 is a diagram illustrating an example of a quantizing process and an inverse quantizing process based on a network band 17. FIG. 6 illustrates one example of the configuration of a part from the feature encoding unit 24 to feature decoding unit 33 in the system 1.

The quantizing unit 25 calculates a quantized value Q, using the NW band 17 (R_pred) that the edge terminal 2 receives and the following Expression (4).

Q=max(1.0,R_act/R_pred) (4)

In the above Expression (4), the term R_act is the actual data volume of data y output from the feature encoding unit 24, and the signal max represents a function that outputs the larger one of the values separated by a comma in the parentheses. According to the above Expression (4), when the actual data volume R_act is smaller than the NW band 17 to be allocated, the quantization value (quantization amount) Q is 1.0, and when the actual data volume R_act is larger than NW band 17 to be allocated, the quantization value Q is R_act/R_pred.

Then, in the quantizing process, the quantizing unit 25 quantizes the encoded data y outputted from the feature encoding unit 24, using the following Expression (5), and obtains the quantized data y_enc.

$$y\_enc = sign ( y ) ⌊ \frac{\vert y \vert}{Q} ⌋ \qquad ( 5 )$$

In the above Expression (5), the symbol sign represents a function for outputting the sign (positive or negative) of the value in the parentheses. The quantizing unit 25 quantizes data y using the calculated quantized value Q according to the above Expression (5), and outputs data y_enc.

In the quantizing unit 25, the entropy encoding process may be performed on the data y_enc.

In addition, in the inverse quantization process, the inverse quantizing unit 32 of the edge server 3 inversely quantizes the quantized data y_enc obtained by the inverse entropy encoding process, using the following Expression (6), and thereby obtains the inversely quantized data y_dec.

y_dec=y_enc·Q (6)

The quantized value Q calculated by the quantizing unit 25 may be transmitted from the edge terminal 2 to the edge server 3. For example, the quantized value Q may be attached to data transmitted from the edge terminal 2, or may be attached to the data y_enc and then subjected to an entropy encoding process or the like.

The transmission-destination determining unit 43 determines the transmission destination 18 of each edge terminal 2 on the basis of the variance value 13 of the current frame image 11 and the calculation power of each edge server 3. The transmission-destination determining unit 43 may determine the transmitting destination 18 further on the basis of the one or more detection results 14 of an object of the one or more previous frame images 11.

For example, the transmission-destination determining unit 43 may calculate the calculation volume C1_pred(i) to be used in an inference process on the feature 12 from the i-th edge terminal 2, using the variance value 13 of the current frame image 11 and the following Expression (7).

C1_pred(i)=C_total*var(i)/Σ var (7)

In the above Expression (7), the term C_total represents the sum of calculation power of the multiple (M+1) edge servers 3.

In addition, when using the one or more detection results 14 to determine the transmission destination 18, transmission-destination determining unit 43 may calculate the calculation volume C2_pred(i) to be used in an inference process on the feature 12 from the i-th edge terminal 2 on the basis of the following Expression (8).

C2_pred(i)=C_total*num(i)/Σnum (8)

Then, the transmission-destination determining unit 43 may calculate calculation volume C_pred(i) based on both the variance value 13 and the detection results 14, using the following Expression (9).

C_pred(i)=(1−k2)*C1_pred(i)+k2*C2_pred(i) (9)

In the above Expression (9), the term k2 is a weighting factor, and may be a value between 0 and 1 both inclusive. The value k2 may be the same as or different from the value k1. When calculating the calculation volume based on the above Expression (9), the transmission-destination determining unit 43 may calculate the calculation volume C_pred(i) based on the weighted sum of C1_pred(i) and C2_pred(i).

If k2=0 is satisfied, the calculation volume based only on the variance value 13 between the variance value 13 and the detection result 14 is calculated like the above Expression (7), and if k2=1 is satisfied, the calculation volume based only on the detection result 14 between the variance value 13 and the detection result 14 is calculated like the above Expression (8). In addition, if 0<k2<1 is satisfied, the calculation volume determined on the basis of the variance value 13 can be corrected according to the number of previous objects based on the detection result 14.

When calculating the calculation volume C1_pred(i) or C_pred(i), the transmission-destination determining unit 43 may hold at least the latest (most recent) calculation volume of each edge terminal 2 in a storing region, such as the memory of the controlling server 4.

The transmission-destination determining unit 43 determines the transmission destination 18 for each edge terminal 2 on the basis of the calculated calculation volume C1_pred(i) or C_pred(i) and the calculation power of the respective edge servers 3.

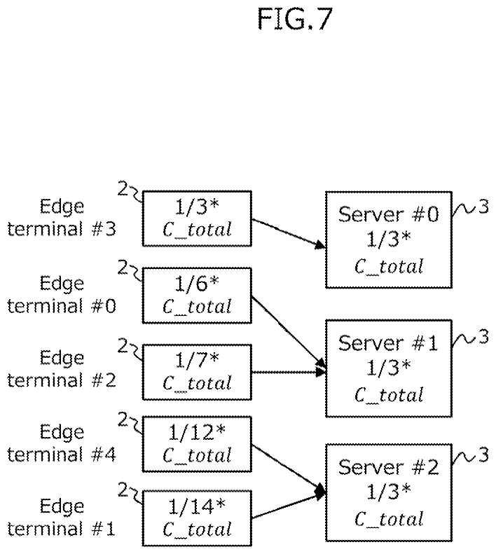

FIG. 7 is a diagram illustrating an example of the determining process of the transmission destination 18. In FIG. 7, the calculation volumes calculated for the respective edge terminals 2 (i.e., the edge terminals #0 to #4) are expressed in such a manner that the ratio to C_total is easily grasped for convenience. For example, the calculation volume of the edge terminal #0 is 1/7*C_total. For simplicity, the calculation power of multiple edge servers 3 (edge server #0 to #2) are the same as one another.

As illustrated in FIG. 7, the transmission-destination determining unit 43 may determine the transmission destination 18 by selecting an edge terminal 2 in the descending order of the magnitude of the calculation volume and allocating the selected edge terminal 2 to an edge server 3 having available calculation power. In the example of FIG. 7, the transmission destination 18 of the edge terminal #3 having a calculation volume of 1/3*C_total is determined to be the edge server #0. In addition, the transmission destination 18 of the edge terminal #0 having a calculation volume of 1/6*C_total and the transmission destination 18 of the edge terminal #2 having a calculation volume of 1/7*C_total are both determined to be the edge server #1. Furthermore, the transmission destination 18 of the edge terminal #4 having a calculation volume of 1/12*C_total and the transmission destination 18 of the edge terminal #1 having a calculation volume of 1/14*C_total are both determined to be the edge server #2.

The transmission-destination determining unit 43 transmits the information of the edge server 3 determined to be the transmission destination 18 to the edge terminal 2. Examples of the information of the edge server 3 include identification information such as an identifier of the edge server 3 and information such as an address of the edge server 3. Examples of the address include various addresses such as an Internet Protocol (IP) address.

The determining process of the transmission destination 18 based on the calculation volume calculated for each edge terminal 2 is not limited to the process illustrated in FIG. 7, and various methods may be used.

As the above, the transmission-destination determining unit 43 may determine the transmitting destination 18 of each edge terminal 2 by feedforward control based on the calculation volume calculated in accordance with a ratio of the variance value 13 of the current frame image 11 received from the edge terminals 2.

Furthermore, the transmission-destination determining unit 43 can correct the calculation volume calculated in the feedforward control by feedback control based on the calculation volume calculated in accordance with the ratio of the number of detected objects in the previous frame images 11 of the edge terminals 2.

Incidentally, in the object detecting process, as the number of objects (for example, persons) included in an image inputted to the object detecting model 16 increases or as the image pattern of the image becomes more complicated, the data volume and the processing loads in the object detection process increase.

The complexity of the pattern in an image, in other words, the difficulty level of the image-based inference process (analysis process) is estimated (calculated) to be an index indicating a data volume and a processing load, such as R_pred and C_pred, based on the magnitude of the variance value 13 by the controlling server 4.

However, if the variance value is calculated from a frame image 11 itself and the frame image 11 has a large size, the calculation of the variance value takes a long time, which may make the system 1 difficult to achieve the real-time object detecting process.

On the other hand, according to the method of the one embodiment, the variance value calculating unit 23 calculates the variance value 13 of the features 12 (intermediate features) outputted from the intermediate layer of the object detecting model 16 by the model former-part processing unit 22. Then, the NW band determining unit 42 and the transmission-destination determining unit 43 estimate one or more indices indicating data volume and the processing load based on the variance value 13 of the intermediate features.

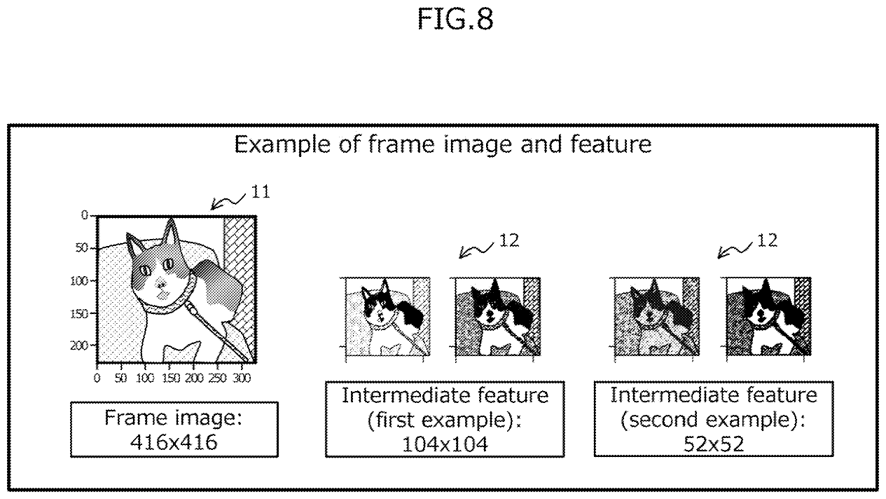

FIG. 8 is a diagram illustrating an example of a frame image 11 and a feature 12. FIG. 8 assumes that the data size (height×width) of a frame image 11 is 416*416.

As illustrated in FIG. 8, the intermediate feature of the object detecting model 16 has a smaller size than that of frame image 11, so that the calculation of variance value 13 takes a shorter time.

For example, if the intermediate feature (first example) is a feature 12 outputted from the convolutional layer 16d (see FIG. 5), the data size is 104*104, which is one sixteenth of the data size of the frame image 11. Further, if the intermediate feature (second example) is a feature 12 outputted from the convolutional layer 16f (see FIG. 5), data size is 52*52, which is one 64th of data size of the frame image 11.

In the DNN of the object detecting model 16 and the like illustrated in FIG. 5, the feature 12 outputted from the layer located at a shallow position, for example, a layer arranged in the model former-part processing unit 22, is information close to the frame image 11 because the entire information of the frame image 11 remains by extracting the edges and the like.

The data volume to be used for feature encoding and the processing load of the inference (analysis) can be estimated on the basis of the magnitude of the variance 13 obtained from the features 12 of the frame image 11. In addition, calculating the variance value 13 based on the feature 12 having smaller data sizes than that of the frame image 11, the variance value calculating unit 23 can shorten the time for calculating process as compared with calculating of the variance value 13 from the frame image 11. Therefore, the system 1 can achieve the object detecting process in real time (or with low delay).

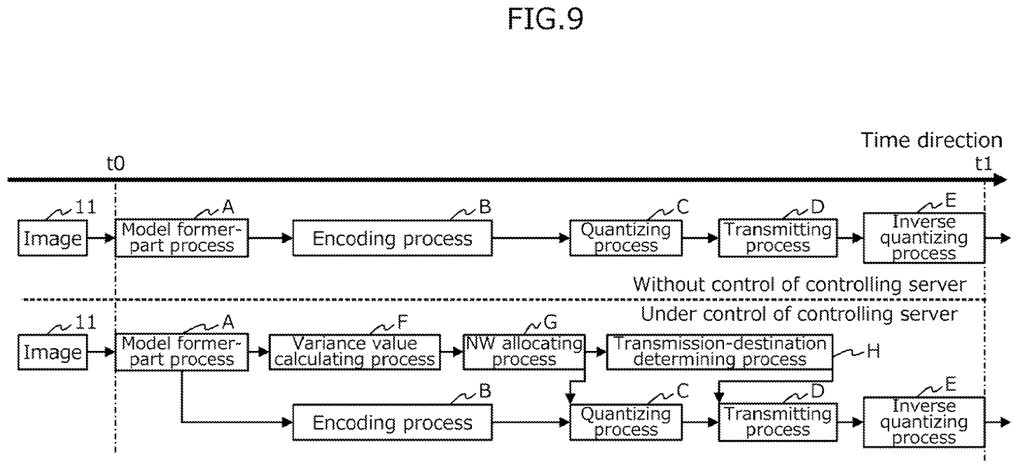

FIG. 9 is a diagram illustrating an example of a timing chart of processes performed in the system 1 of the one embodiment. In FIG. 9, the upper part separated by a broken line indicates a process performed without the control by the controlling server 4, and the lower part separated by the broken line indicates a process performed under the control of the controlling server 4.

In the upper part of FIG. 9, at the timing to, model former-part processing unit 22 of the edge terminal 2 executes a model former-part process A on the frame image 11. The feature encoding unit 24 executes an encoding process B based on the feature 12 outputted from the model former-part process.

The quantizing unit 25 performs a quantizing process (and an entropy encoding process) C, i.e., a pre-transmitting process, on the encoded feature 12. The transmitting unit 26 executes a transmitting process D of the transmission data having been subjected to the pre-transmitting process.

The inverse quantizing unit 32 of the edge server 3 performs an inverse quantizing process E on the data received by the receiving unit 31, and outputs the encoded data at the timing t1. In both the upper and lower parts of FIG. 9, the above-described processes performed by the feature decoding unit 33, the model latter-part processing unit 34, and the storing unit 35 are executed after the inverse quantizing process E.

In the lower part of FIG. 9, in addition to the processes in the upper part of FIG. 9, the variance value calculating unit 23 executes, in parallel with the encoding processing B, a variance value calculating process F that calculates the variance value 13 based on the features 12 outputted from model former-part process and transmits calculated variance 13 to the controlling server 4.

The NW band determining unit 42 of the controlling server 4 performs, in parallel with the encoding process B, a NW allocating process G that determines the NW band 17 based on the variance value 13 received by the controlling server 4 and transmits the determined NW band 17 to the edge terminal 2.

The quantizing unit 25 of the edge terminal 2 performs the quantizing process C based on the result of the encoding process B and the NW band 17 determined in the NW allocating process G.

In addition, the transmission-destination determining unit 43 performs, in parallel with quantizing unit 25, a transmission destination determining process H that determines transmission destination 18 based on the variance value 13 and the calculation power of the edge server 3 and transmits the determined transmitting destination 18 to the edge terminal 2. The transmission destination determining process H may be executed at least partially in parallel with the NW allocating process G.

The transmitting unit 26 of the edge terminal 2 executes the transmitting process D based on the result of the process performed by quantizing unit 25 and the transmission destination 18 determined by the transmission destination determining process H. The inverse quantizing unit 32 of the edge server 3 performs an inverse quantizing process E on the transmission data received by the receiving unit 31, and outputs the encoded data at the timing t1.

As described above, the processes F to H performed by the variance value calculating unit 23, the NW band determining unit 42, and the transmission-destination determining unit 43 can accomplish a pipeline process in conjunction with the encoding process B, the quantizing process C and the like. Therefore, the processing delay of the entire system 1 caused by performing the processes F to H can be suppressed to be low (zero or short time) as compared with the upper part of FIG. 9.

As described above, the controlling server 4 controls estimation of a processing load (analysis load) and the data volume of the inference process of a machine learning process based on the statistic information of the current frame image 11, such as the variance value 13 of the feature 12. Then, the controlling server 4 determines the NW band 17 and the transmission destination 18 allocated to each edge terminal 2 on the basis of the estimation result.

Since this control can accurately estimate the processing load and the data volume of the current frame image 11 at a low latency, a real-time inference process can be accomplished. In other words, the system 1 can appropriately control an inference process of the object detecting process or the like in accordance with the inputted frame image 11.

Further, the controlling server 4 corrects the control to deal with an inference load estimated on the basis of the variance by control that estimates the inference load based on the inference result (analysis result) of the one or more previous frame images 11. This can enhance the accuracy of the control by the controlling server 4, following a change in the content of the frame images 11 over time, for example, a change of the number of objects.

### (D) Example of Operation

Next, description will now be made in relation to an example of the operation of the system 1 according to the one embodiment. As the preprocess, for example, it is assumed that the former part obtained by dividing the object detecting model 16 is arranged in each of multiple edge terminals 2 and the latter part of the object detecting model 16 is arranged in each of multiple edge servers 3 at a predetermined timing before the start of the operation of system 1. In addition, as a preprocess or a periodic process, each of the multiple edge servers 3 transmits information indicating calculation power of the edge server 3 to the controlling server 4.

(D-1) Example of Operation of Edge Terminal:

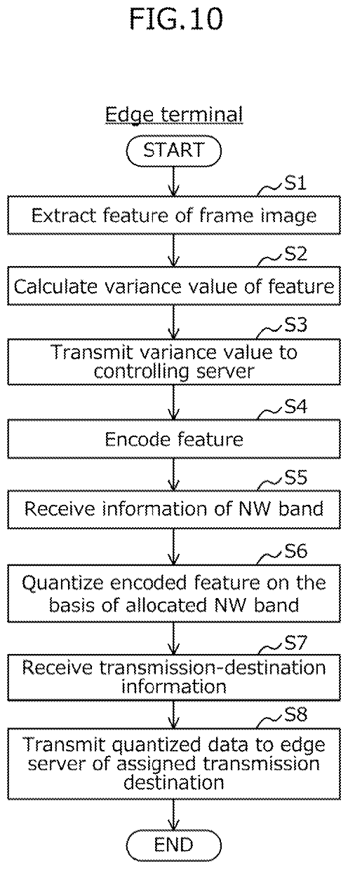

FIG. 10 is a flow diagram illustrating an example of an operation of an edge terminal 2 of the one embodiment. It is assumed that the process illustrated in FIG. 10 is executed each time the image obtaining unit 21 obtains a frame image 11 in each of multiple edge terminals 2.

As illustrated in FIG. 10, the model former-part processing unit 22 of the edge terminal 2 extracts a feature 12 of a frame image 11 from the last layer of the former part of the object detecting model 16 by inputting a frame image 11 that the image obtaining unit 21 obtains into the former part (Step S1).

The variance value calculating unit 23 calculates the variance value 13 of feature 12 (Step S2), and transmits the calculated variance value 13 to the controlling server 4 (Step S3).

The feature encoding unit 24 performs an encoding process on the feature 12 (Step S4). The step S4 may be performed in parallel with Step S2 and Step S3.

The edge terminal 2 receives information (for example, R_pred) of the NW band 17 from the controlling server 4 (Step S5).

The quantizing unit 25 performs pre-transmitting process such as a quantizing process (and an entropy encoding process) on the encoded feature 12 on the basis of the allocated NW band 17 (Step S6). The quantizing process may include calculation of the quantized value Q based on the NW band 17 and quantization based on the quantized value Q.

The edge terminal 2 receives information of the transmission destination 18 from the controlling server 4 (Step S7). Step S7 may be performed at any timing between Steps S4 and S6.

The transmitting unit 26 transmits the quantized data (transmission data having been subjected to the pre-transmitting process) to the designated transmission destination 18 (Step S8), and the process ends. The transmission data may include a quantized value Q.

(D-2) Example of Operation of Edge Server:

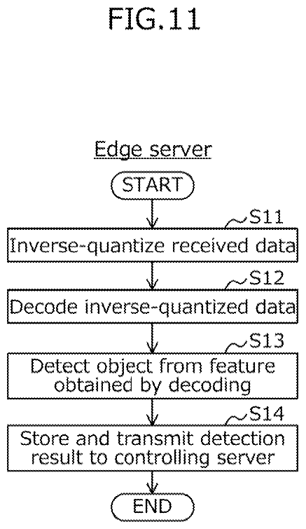

FIG. 11 is a flow diagram illustrating an example of an operation of an edge server 3 of the one embodiment. The process of FIG. 11 is executed each time each of the multiple edge server 3 receive data from the edge terminal 2.

As illustrated in FIG. 11, the inverse quantizing unit 32 of the edge server 3 performs pre-decoding process such as (the inverse entropy encoding process and) the inverse quantizing process on data received by the receiving unit 31 from the edge terminal 2 (Step S11). The inverse quantizing process may include quantization based on the quantized value Q received from the edge terminal 2.

The feature decoding unit 33 obtains the feature 12 by performing a decoding process on the inverse-quantized data (data having been subjected to the pre-decoding process) (Step S12).

The model latter-part processing unit 34 detects an object from a feature 12 obtained in the decoding by inputting the feature 12 into the latter part of the object detecting model 16 (Step S13).

The storing unit 35 stores the detection result 14 of the object and transmits the detection result 14 to the controlling server 4 (Step S14), and the process ends.

(D-3) Example of Operation of Controlling Server:

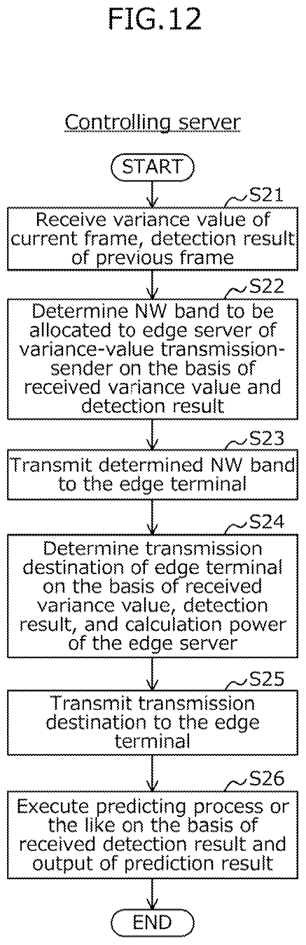

FIG. 12 is a flow diagram illustrating an example of an operation of the controlling server 4 of the one embodiment. The process illustrated in FIG. 12 is assumed to be executed each time the controlling server 4 receives the variance value 13 from each of the multiple edge terminal 2.

As illustrated in FIG. 12, the controlling unit 41 of the controlling server 4 receives the variance value 13 of the current frame image 11 from the edge terminal 2, and receives the detection result 14 of the object in the previous frame image 11 from edge server 3 (Step S21).

On the basis of the received variance value 13 and the received detection result 14, the NW band determining unit 42 determines the NW band 17 to be distributed (allocated) to the edge terminal 2 serving as the sender of the variance value 13 (step S22).

The NW band determining unit 42 transmits information of the determined NW band 17 to the edge terminal 2 (Step S23).

On the basis of the received variance value 13, the detection result 14, and the calculation power of the edge server 3, the transmission-destination determining unit 43 determines the transmission destination 18 of data from multiple edge terminals including the edge terminal 2 serving as the sender of the variance value 13 (Step S24).

The transmission-destination determining unit 43 transmits the information of the determined transmission destination 18 to each edge terminal 2 (Step S25). Steps S24 and S25 may be performed before Step S21, or may be performed at least partially in parallel with the processes of Steps S24 and S25.

On the basis of the detection result 14 received from the edge server 3, the controlling unit 41 performs a process such as a prediction process and outputs the process result (Step S26), and then the process ends.

### (E) Modifications

The one embodiment assumes that the variance value calculating unit 23 calculates the variance value 13 of the feature 12 outputted from model latter-part processing unit 34, and the controlling server 4 determines the NW band 17 and the transmission destination 18 based on the variance value 13, but is not limited thereto.

(E-1) First Modification;

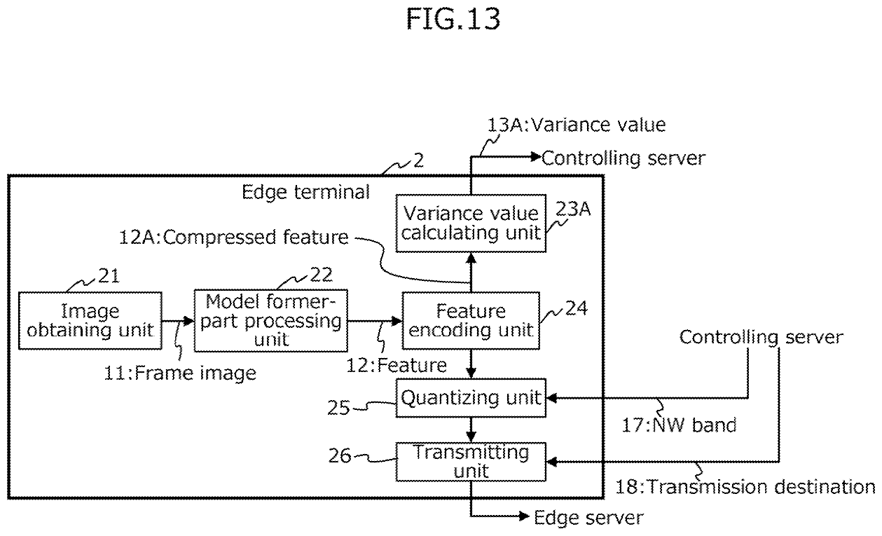

FIG. 13 is a block diagram illustrating an example of a software configuration of an edge terminal 2 according to a first modification. As illustrated in FIG. 13, the edge terminal 2 of the first modification may include a variance value calculating unit 23A in place of the variance value calculating unit 23.

The variance value calculating unit 23A may calculate a variance value 13A of compressed feature 12A outputted from the feature encoding unit 24 and transmit the calculated variance value 13A to the controlling server 4.

The edge terminal 2 according to the first modification can bring the same advantages as those of the one embodiment and additionally, since the variance value 13A is calculated on the basis of the compressed features 12A smaller in data size than the features 12, the second modification can reduce the processing load on the edge terminal 2 as compared with the one embodiment.

For example, when the calculation power (performance) of the processor or another device of the edge terminal 2 is small, it may be difficult to perform the encoding process B and the variance value calculation process F of FIG. 9 in a pipeline, and the encoding process B and the variance value calculation process F may be sequentially processed.

In such a circumstance, the variance value calculating unit 23A can shorten the processing time, as compared with calculating of the variance value 13 based on the feature 12, by calculating the variance value 13A based on the compressed features 12A in the variance value calculating process F. This can reduce the processing delay of the system 1.

(E-2) Second Modification:

Each camera 20 may be an imaging capturing device that captures images from a fixed position, such as a monitoring camera. If camera 20 is a monitoring camera or the like, the chronological variation of the background images (background part) in the frame image 11 that the camera 20 outputs is small.

In the second modification, the image obtaining unit 21 or the model former-part processing unit 22 may hold the background image in a storing region such as a memory of the edge terminal 2, and calculate a difference image (an image of a difference region) that is a difference between the current frame image 11 and the background image.

In this circumstance, the model former-part processing unit 22 may extract the feature 12 of the difference image by inputting the difference image into the former part of the object detecting model 16. In addition, the variance value calculating unit 23 may calculate the variance value 13 of the feature 12 of the difference image and transmit the calculated variance value 13 to the controlling server 4. Furthermore, the NW band determining unit 42 and the transmission-destination determining unit 43 may determine the NW band 17 and the transmission destination 18 based on the variance value 13.

The feature encoding unit 24, the quantizing unit and the transmitting unit 26 may perform the encoding process, the quantizing process (the pre-transmitting process), and the transmitting process on the features 12 of the difference image.

As described above, the use of the feature 12 of the difference image obtained by extracting a region having a high possibility that an object exists in the frame image 11 can enhance the accuracy of the data volume to be used for feature encoding estimated on the basis of the magnitude of the variance value 13 obtained from the feature 12 and also the accuracy of processing load of the inference (analysis). Consequently, the inference accuracy (the detection accuracy of an object) in the edge server 3 can be improved.

The second modification may be implemented in combination with the first modification. For example, the variance value calculating unit 23A may calculate a variance value 13A of the compressed feature 12A obtained by the feature encoding unit 24 encoding the features 12 of the difference image.

For example, the functional blocks 21 to 26 included in each edge terminal 2 illustrated in FIG. 4 or FIG. 13 may be merged or divided in any combination. Further, for example, the functional blocks 31 to 35 included in each edge server 3 illustrated in FIG. 4 may be merged or divided in any combination. Further, for example, the functional blocks 41 to 43 included in controlling server 4 illustrated in FIG. 4 may be merged by various combination or may be divided.

### (F) Example of Hardware Configuration

The edge terminals 2, the edge servers 3, and the controlling server 4 according to the one embodiment may be each a virtual server (VM) or a physical server. The function of each of the edge terminals 2, the edge servers 3, and the controlling server 4 may be achieved by a single computer or by two or more computers.

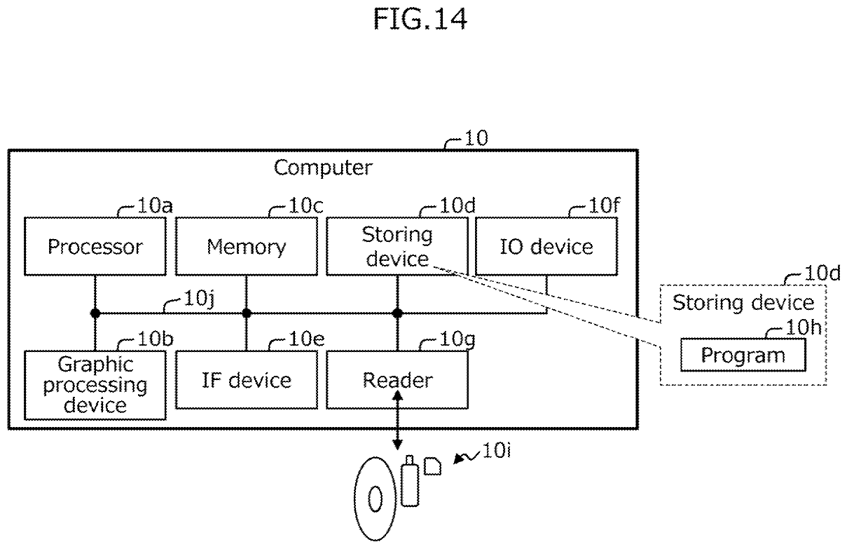

Hereinafter, description will now be made in relation to a computer 10 illustrated in FIG. 14 as an example of a computer that achieves the function of each of the edge terminals 2, the edge servers 3, and the controlling server 4.

FIG. 14 is a block diagram illustrating an example of a hardware configuration of a computer 10 of the one embodiment. If multiple computers are used as the HW resources for achieving the functions of each of the edge terminals 2, the edge servers 3, and the controlling server 4, each of the computers may have the HW configuration illustrated in FIG. 14.

As illustrated in FIG. 14, the computer 10 may illustratively include a HW configuration formed of a processor 10a, a graphic processing device 10b, a memory a storing device 10d, an IF (Interface) device 10e, an IO (Input/Output) device 10f, and a reader 10g.

The processor 10a is an example of an arithmetic operation processing device that performs various controls and calculations. The processor 10a may be communicably connected to the blocks in the computer 10 via a bus 10j. The processor 10a may be a multiprocessor including multiple processors, may be a multicore processor having multiple processor cores, or may have a configuration having multiple multicore processors.

The processor 10a may be any one of integrated circuits (ICs) such as Central Processing Units (CPUs), Micro Processing Units (MPUs), Accelerated Processing Units (APUs), Digital Signal Processors (DSPs), Application Specific ICs (ASICs) and Field Programmable Gate Arrays (FPGAs), or combinations of two or more of these ICs.

The graphic processing device 10b executes an screen displaying control on an outputting device such as a monitor included in the IO device 10f. The graphic processing unit has a configuration as an accelerator that executes a machine learning process and an inference process using a machine learning model. Examples of the graphic processing device 10b are ICs such as Graphics Processing Units (GPUs), APUs, DSPs, ASICs, and FPGAs.

The model former-part processing unit 22 of an edge terminal 2 illustrated in FIG. 4 may cause the graphic processing device 10b of the edge terminal 2 to execute the former part of the inference process of the object detecting model 16 using the frame image 11 as an input and may thereby obtain a feature 12 from the graphic processing device 10b.

The model latter-part processing unit 34 of an edge server 3 illustrated in FIG. 4 may cause the graphic processing device 10b of the edge server 3 to execute the latter part of the inference process of the article detecting model 16 using the frame image 11 as an input and may thereby obtain a detection result 14 from the graphic processing device 10b.

The memory 10c is an example of a HW device that stores various types of data and information such as a program. Examples of the memory 10c include one of or the both of a volatile memory such as a Dynamic Random Access Memory (DRAM) and a non-volatile memory such as a Persistent Memory (PM).

The storing device 10d is an example of a HW device that stores various types of data and information such as program. Examples of the storing device 10d include a magnetic disk device such as a Hard Disk Drive (HDD), a semiconductor drive device such as a Solid State Drive (SSD), and various storing devices such as a nonvolatile memory. Examples of the nonvolatile memory include a flash memory, a Storage Class Memory (SCM), and a Read Only Memory (ROM).

As a storing region that stores various data of each of the edge terminals 2, the edge servers 3, and the controlling server 4, one of or the both the memory 10c and the storing device 10d of each of the edge terminals 2, the edge servers 3, and the controlling server 4 may be used.

The storing device 10d may store a program 10h (image processing program) that implements all or part of various functions of the computer 10.

For example, in the computer 10 of each edge terminal 2, the processor 10a can achieve the functions of the blocks 21-26 illustrated in FIG. 4 or 13 by expanding the program 10h stored in the storing device 10d onto the memory 10c and executing the expanded program 10h. Besides, in the computer 10 of each edge server 3, the processor 10a can achieve the functions of the blocks 31-35 illustrated in FIG. 4 by expanding the program 10h stored in the storing device 10d onto the memory 10c and executing the expanded program 10h. Furthermore, in the computer 10 of the controlling server 4, the processor 10a can achieve the functions of the blocks 41-43 illustrated in FIG. 4 by expanding the program 10h stored in the storing device 10d onto the memory 10c and executing the expanded program 10h.

The IF device 10e is an example of a communication IF that controls connection and communication between the computer 10 and another computer. For example, the IF device 10e may include an applying adapter conforming to Local Area Network (LAN) such as Ethernet (registered trademark) or optical communication such as Fibre Channel (FC). The applying adapter may be compatible with one of or the both wireless and wired communication schemes.

For example, through the IF device 10e and the NW 1a or another NW, each of the edge terminals 2, the edge servers 3, and the controlling server 4 may carry out data communication such as the transmission data, the dispersed value 13, the detection result 14, the NW band 17, the receiver 18, and the arithmetic operation power. The program 10h may be downloaded from a network to the computer through the communication IF and stored into the storing device 10d.

The IO device 10f may include one of or the both an input device and an output device. Examples of the input device include a keyboard, a mouse, and a touch panel. Examples of the output device include a monitor, a projector, and a printer. The IO device 10f may include, for example, a touch panel that integrates an input device and an output device. The output device may be connected to the graphic processing device 10b.

The reader 10g is an example of a reader that reads data and programs recorded on a recording medium 10i. The reader 10g may include a connecting terminal or device to which the recording medium 10i can be connected or inserted. Examples of the reader 10g include an applying adapter conforming to, for example, Universal Serial Bus (USB), a drive apparatus that accesses a recording disk, and a card reader that accesses a flash memory such as an SD card. The program 10h may be stored in the recording medium 10i. The reader 10g may read the program 10h from the recording medium 10i and store the read program 10h into the storing device 10d.

The recording medium 10i is an example of a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is exemplary. Accordingly, the computer 10 may appropriately undergo increase or decrease of HW devices (e.g., addition or deletion of arbitrary blocks), division, integration in an arbitrary combination, and addition or deletion of the bus.

As one aspect, the present embodiment can appropriately control an inference process according to multiple inputted images obtained by multiple devices in an image processing system in which multiple servers perform the inference processes on the inputted images.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An image processing system comprising:
a plurality of devices that obtain a plurality of inputted images;
a plurality of servers that perform an inference process on the plurality of inputted images; and
a controlling apparatus that controls the plurality of devices and the plurality of servers, wherein
a first device that obtains a first inputted image and that is one of the plurality of devices is configured to
obtain a first feature of the first inputted image by inputting the first inputted image into a former-part layer of a machine learning model, the machine learning model performing the inference process on an image inputted,
calculate statistics information of the first feature and transmit the statistics information to the controlling apparatus, and
transmit the first feature to a first server based on a network band determined by the controlling apparatus, the first server being determined among the plurality of servers by the controlling apparatus,
the controlling apparatus is configured to determine the network band and the first server based on the statistics information received from the first device and performance of each of the plurality of servers, the network band being allocated to the first device,
the first server is configured to obtain an inference result by inputting the first feature received from the first device into a latter-part layer of the machine learning model.

2. The image processing system according to claim 1, wherein
each of the plurality of servers is further configured to transmit an inference result based on the received feature to the controlling apparatus;
the controlling apparatus determines, in a process of determining the network band and the first server, the network band and the first server further based on a first inference result received from at least one of the plurality of servers, the first inference result being based on a second feature of a second inputted image previous in time to the first inputted image.

3. The image processing system according to claim 2, wherein
the inference processing is a process of detecting an object,
the controlling apparatus, in a process of determining the network band and the first server,
estimates a number of detected objects in the first inputted image based on the statistics information and the first inference result indicating a number of detections of objects in the second inputting image, and
determines the network band and the first server based on the statistics information, the performance of each of the servers, and the number of detected objects in the first inputted image.

4. The image processing system according to claim 1, wherein
in a process of transmitting the first feature, the first device
encodes the first feature; quantizes, based on the network band determined by the controlling device, the encoded first feature; and
transmits the quantized first feature to the first server.

5. The image processing system according to claim 4, wherein
in a process of calculating the statistics information, the first device calculates the statistics information of the encoded first feature.

6. The image processing system according to claim 1, wherein
in a process of obtaining the first feature, the first device obtains the first feature by inputting, into the former-part layer of the machine learning model, a difference image between the first inputted image photographed by an image-capturing device that photographs images at a fixed position and a background image of an image photographed by the image-capturing device.

7. A computer-implemented method for image processing in an image processing system, the image processing system including a plurality of devices that obtain a plurality of inputted images, a plurality of servers that perform an inference process on the plurality of inputted images; and a controlling apparatus that controls the plurality of devices and the plurality of servers, the computer-implemented method comprising:
at a first device that obtains a first inputted image and that is one of the plurality of devices,
obtaining a first feature of the first inputted image by inputting the first inputted image into a former-part layer of a machine learning model, the machine learning model performing the inference process on an image inputted,
calculating statistics information of the first feature and transmit the statistics information to the controlling apparatus, and
transmitting the first feature to a first server based on a network band determined by the controlling apparatus, the first server being determined among the plurality of servers by the controlling apparatus;
at the controlling apparatus,
determining the network band and the first server based on the statistics information received from the first device and performance of each of the plurality of servers, the network band being allocated to the first device; and
at the first server,
obtaining an inference result by inputting the first feature received from the first device into a latter-part layer of the machine learning model.

8. The computer-implemented method according to claim 7, further comprising
at each of the plurality of servers,
transmitting an inference result based on the received feature to the controlling apparatus;
at the controlling apparatus,
determining, in the determining of the network band and the first server, the network band and the first server further based on a first inference result received from at least one of the plurality of servers, the first inference result being based on a second feature of a second inputted image previous in time to the first inputted image.

9. The computer-implemented method according to claim 8, wherein
the inference processing is a process of detecting an object, and
the computer-implemented method further comprises
at the controlling apparatus, in the determining of the network band and the first server,
estimating a number of detected objects in the first inputted image based on the statistics information and the first inference result indicating a number of detections of objects in the second inputting image, and
determining the network band and the first server based on the statistics information, the performance of each of the servers, and the number of detected objects in the first inputted image.

10. The computer-implemented method according to claim 7, further comprising:
at the first device, in the transmitting of the first feature,
encoding the first feature;
quantizing, based on the network band determined by the controlling device, the encoded first feature; and
transmitting the quantized first feature to the first server.

11. The computer-implemented method according to claim 10, further comprising:
at the first device, in the calculating of the statistics information,
calculating the statistics information of the encoded first feature.

12. The computer-implemented method according to claim 7, further comprising:
at the first device, in the obtaining of the first feature,
obtaining the first feature by inputting, into the former-part layer of the machine learning model, a difference image between the first inputted image photographed by an image-capturing device that photographs images at a fixed position and a background image of an image photographed by the image-capturing device.
